(19) United States
(12) Patent Application Publication
(10) Pub. No.: US 2025/0030305 A1
(43) Pub. Date: Jan. 23, 2025

(54) ROTOR SHAFT WITH LOCALIZED SPLINES FOR KEYWAYS

(71) Applicant: METAL FORMING & COINING CORPORATION, Maumee, OH (US)

(72) Inventors: Timothy John Cripsey, Rochester, MI (US); Robert John-Luke Herston, New Baltimore, MI (US); Alexander Christopher VanSchaikMartinet, Clinton Township, MI (US)

(21) Appl. No.: 18/775,798

(22) Filed: Jul. 17, 2024

Related U.S. Application Data
(60) Provisional application No. 63/513,937, filed on Jul. 17, 2023.

(51) Int. Cl. H02K 7/00; B23C 3/30; F16C 3/02

(52) U.S. Cl. CPC H02K 7/003; B23C 3/30; F16C 3/02

(57) ABSTRACT

A rotor shaft includes a tubular shaft having an inner surface, an outer surface, a first end, and an opposing second end. At least one keyway is formed in the outer surface of the tubular shaft. An inner diameter of the tubular shaft is aligned with the at least one keyway is less than an inner diameter of the tubular shaft not radially with the at least one keyway.

### CROSS REFERENCE TO RELATED APPLICATIONS

This application claims the benefit of U.S. Provisional Application No. 63/513,937, filed on Jul. 17, 2023. The entire disclosure of the above application is hereby incorporated herein by reference.

### FIELD OF THE INVENTION

The invention relates to a rotor shaft with keyways and process of forming the rotor shaft with keyways for an electric motor of an electrical vehicle powertrain.

### BACKGROUND OF THE INVENTION

As known, rotor shafts are configured for coupling to a rotor of an electrical component such as an electric motor of an electric vehicle powertrain, for example. Certain challenges are presented in electric vehicle powertrains compared to traditional powertrain architectures such as maintaining greater desired RPMs (revolutions per minute) of rotating parts, noise reduction, and efficient heat transfer capabilities.

Rotor shafts originally were formed as solid machined forged shafts. However, in order to move to a lighter weight configuration, the solid rotor shafts included a center drilling. This, in turn, led to hollow annular shafts to provide greater weight minimization. Therefore, desireably, many rotor shafts are formed as hollow shafts with a wall thickness.

Advantageously, axial keyways are often required and formed on the rotor shafts, particularly the outer surface of the rotor shafts. The keyways are channels or slots machined in the rotor shafts and configured to facilitate coupling to another component such as a rotor, another shaft, or another engine or drivetrain component, as desired. The keyways receive as key or protuberance formed on the other component. The keyways and key system facilitate alignment and coupling of the components and militate against slipping of the components on the shaft.

Because the keyways are formed in the outer surface of the rotor shaft, the wall thickness of the rotor shaft at the keyways is less than the wall thickness at remaining portions of the rotor shaft between the keyways. Additionally, strength, load, and/or consumer requirements dictate a minimum wall thickness. Therefore, the wall thickness at the keyways cannot be less than the required minimum wall thickness. To accommodate such wall thicknesses, the remaining portions of the rotor shaft must have a wall thickness greater than or equal to a sum of the required minimum wall thickness plus a thickness equal to a depth of the keyways. As a result, the minimum required wall thickness is always achieved. However, the wall thickness of the rotor shaft at the remaining portions between the keyways is thicker than required or necessary and results in an undesired weight increase.

In applications where maintaining cross-sectional thickness is critical for the structural integrity of the rotor shaft, it is therefore desired to have a rotor shaft formed with internal features where wall thickness can be held consistently throughout the shaft while minimizing a weight of the shaft and consolidating overall rotor shaft system components and maximizing cost and manufacturing efficiency.

### SUMMARY OF THE INVENTION

In accordance and attuned with the instant disclosure, a rotor shaft formed with internal features where wall thickness can be held consistently throughout the shaft while minimizing a weight of the shaft, consolidating overall rotor shaft system components, and maximizing cost and manufacturing efficiency has surprisingly been discovered.

According to an embodiment of the disclosure, a rotor shaft includes a tubular shaft having an inner surface, an outer surface, a first end, and an opposing second end. At least one keyway is formed in the outer surface of the tubular shaft. An inner diameter of the tubular shaft is aligned with the at least one keyway is less than an inner diameter of the tubular shaft not radially with the at least one keyway.

According to another embodiment of the disclosure, a rotor shaft for an electric vehicle includes a tubular shaft having an inner surface, an outer surface, a first end, and an opposing second end. At least one keyway is formed in the outer surface of the tubular shaft, wherein a thickness of the tubular shaft aligned with the at least one keyway is substantially equal to or greater than a thickness of the tubular shaft not aligned at the at least one keyway.

According to yet another embodiment of the disclosure, a method of forming a tubular shaft includes the steps of providing a preform and manipulating the preform to form a tubular shaft through a flowforming process, wherein an inner surface of the tubular shaft includes a spline extending along a length of the tubular shaft.

### DRAWINGS

The above, as well as other advantages of the present invention, will become readily apparent to those skilled in the art from the following detailed description of a preferred embodiment when considered in the light of the accompanying drawings in which:

FIG. 1 is a front perspective view of a shaft according to an embodiment of the present disclosure;

FIG. 2 is a left side elevational view of the shaft of FIG. 1;

FIG. 3 is a fragmentary enlarged view of the shaft of FIGS. 1-2 without keyways, highlighting a process step of the present disclosure; and

FIG. 4 is a flow diagram illustrating a method of forming the shaft of FIGS. 1-2.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the order of the steps presented is exemplary in nature, and thus, is not necessary or critical.

Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

As used herein, “substantially” means “to a considerable degree,” “largely,” or “proximately” as a person skilled in the art in view of the instant disclosure would understand the term. “A” and “an” as used herein indicate “at least one” of the item is present; a plurality of such items may be present, when possible. Spatially relative terms, such as “front,” “back,” “inner,” “outer,” “bottom,” “top,” “horizontal,” “vertical,” “upper,” “lower,” “side,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The present technology relates to shafts such as rotor shafts, used in electric vehicles. However, the present disclosure can apply to other types of shafts used in any vehicle or in other applications. Shafts according to the disclosure are configured to facilitate a transmission of rotational forces and torque between components of a vehicle.

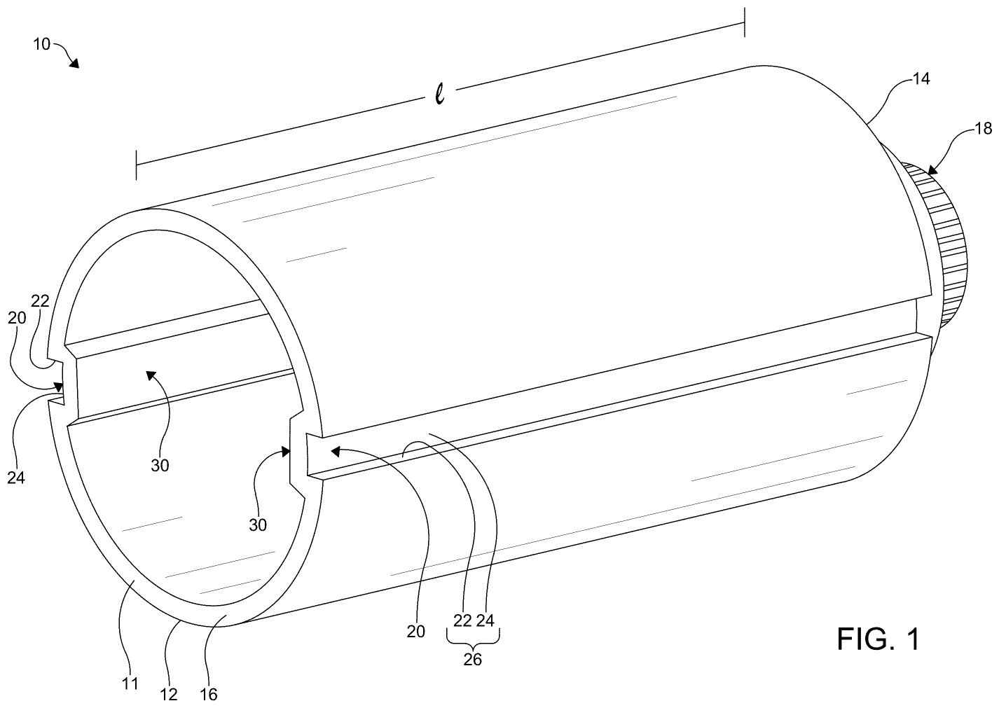

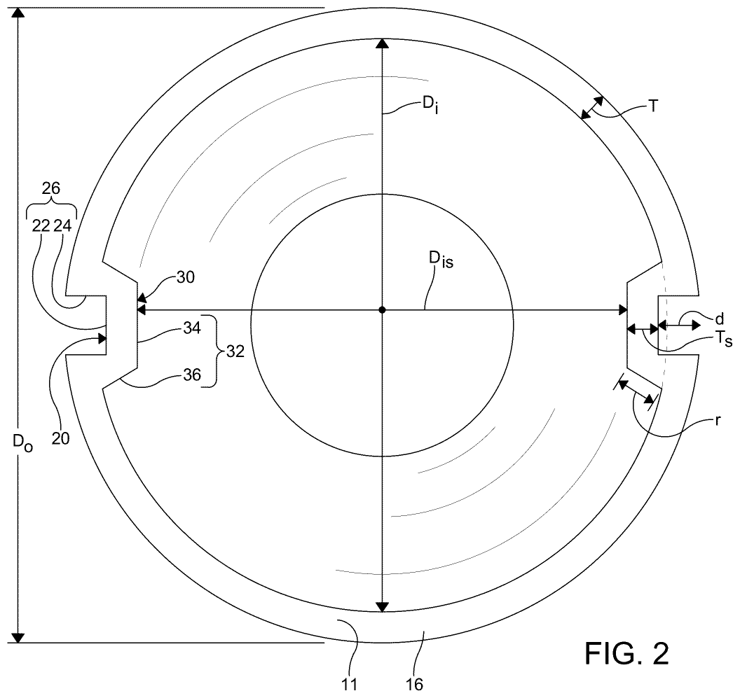

FIGS. 1-2 illustrate a shaft 10 according to an embodiment of the instant disclosure. The shaft 10 is configured as a rotor shaft for providing mechanical communication between components of an electric vehicle such as between a rotor and another component of the drivetrain. However, it is understood the shaft 10 is configured for other applications or uses for any type of vehicle or non-vehicle type uses. The shaft 10 is configured for transmitting torque between the components.

As shown, the shaft 10 is a first half shaft configured for coupling to a second half shaft (not shown). The shaft 10 is tubular or hollow defining a wall 11 having a wall thickness T and includes a first end 12 and an opposing second end 14. A planar interfacing surface 16 is formed at the first end 12. The interfacing surface 16 extends along a plane substantially perpendicular to a center axis c of the shaft 10. The interfacing surface 16 is configured to engage and couple to an interfacing surface of the second half shaft to form a fully assembled full shaft. The half shafts can be coupled to each other at the respective interfacing surfaces by a weld such as a laser weld, for example. However, other welds, adhesive, coupling devices and/or methods can be employed to couple the half shafts to each other without departing from a scope of the present disclosure. It is understood, other components can be coupled or positioned between the half shafts as desired, wherein the half shafts are spaced from one another but axially and mechanically aligned. Center supports can also be included at or approximate to the interfacing surfaces of the half shafts.

An outer diameter Do and an inner diameter Dᵢ of the shaft 10 is substantially constant along a length/thereof, except as mentioned and described in further detail below. However it is understood the diameters Dₒ, Dᵢ can vary as desired along a length/of the shaft 10 depending on the application of the shaft 10 without departing from the scope of the disclosure. The second end 14 includes a boss 18 or extension configured for coupling to another component of the vehicle to transmit torque thereto. As shown, the outer diameter De of the shaft 10 decreases at the boss 18. However, it is understood the outer diameter Do can remain constant or increase at the boss 18, if desired. Additionally, the boss 18 can be integrally formed with or separately formed from and coupled to the remaining portions of the shaft 10.

A pair of diametrically opposing keyways 20 are formed in an outer surface of the shaft 10. The keyways 20 extend along the length/of the shaft 10 and are elongate slots or indentations within the outer surface of the shaft 10. While one pair of keyways 20 are shown, it is understood more than one pair of diametrically opposed keyways 20 can be formed in the outer surface of the shaft 10. Additionally, any number of keyways 20 fewer than or more than two keyways can be formed, with or without a diametrically opposing keyway counterpart, in the outer surface of the shaft 10, as desired. The keyways 20 are configured for receiving and engaging keys or splines (not shown) of another component to facilitate torque transmission, alignment, and engagement and militate against slipping between the shaft 10 and the component. The keyways 20 have a substantially rectangular cross-sectional shape to correspond to the keys of the component defined by a pair of opposing wall surfaces 22 and an innermost surface 24 forming a substantially U-shaped surface profile. However, any cross-sectional shape can be contemplated as desired depending on the corresponding splines. For example, the keyways 20 can have trapezoid or any other polygonal shape. In another example, the keyways 20 can have a single arcute surface forming a semi-circular cross-sectional shape of the keyways 20, or a combination of rectilinear and arcuate portions. As shown, the keyways 20 extend along an entirety of the length l of the shaft 10. However, the keyways 20 can extend along only a portion of the length l of the shaft 10 or intermittently along the length/of the shaft 10.

A pair of diametrically opposing inner splines 30 are formed on the inner surface of the shaft 10. The splines 30 extend radially inwardly from the inner surface of the shaft 10 and are in radial alignment with the keyways 20. In other words, the splines 30 are formed at the same circumferential positions of the wall 11 as the keyways 20 but on opposing surfaces of the wall 11. The splines 30 have cross-sectional surface profile 32 corresponding to a geometry of the corresponding keyways 20. For example, as illustrated, the keyways 20 have the rectangular cross-sectional shape. As a result, the surface profile 32 is defined by a rectilinear surface 34 parallel to and offset from the innermost surface 24 of the corresponding one of the keyways 20. A pair of side walls 36 extend between the inner surface of the shaft 10 and the rectilinear surface 34. Each of the side walls 36 extend at an obtuse angle with respect to the rectilinear surface 34. As a result of the profile 32, the splines 30 have a cross-sectional shape that is substantially trapezoidal. The cross-sectional shape facilitates both an case in forming the splines 30 and to maintain a desired minimum wall thickness Tₘ of the shaft 10. However, it is understood the side walls 36 can extend at an acute or right angle if desired.

A depth d of the keyways 20 can be any depth as desired corresponding to the keys of the component the shaft 10 is coupling to. The depth d influences and determines a desired distance r that the side walls 36 extend from the inner surface of the shaft 10 to form the splines 30, wherein a thickness Tₛ of the shaft 10 at the splines 30 is the desired minimum thickness Tₘ. For example, the thickness Tₛ of the shaft 10 at the splines 30 is substantially equal to or greater than the thickness T of the other portions of the shaft 10 not at the splines 30 or between the splines 30. For explanatory purposes, a minimum desired thickness of the shaft 10 will be represented by Tₘ. Therefore, if the depth d of the keyways 20 are greater than or equal to the thickness T of the shaft 10 at the portions of the shaft 10 not at the splines 30, then the splines 30 must extend from the inner surface of the shaft 10 at a minimum distance dₘ equal to (d−T)+Tₘ. Alternately, if the depth d of the keyways 20 is less than the thickness T of the shaft 10 at the portions of the shaft not at the splines 30, then the splines 30 must extend at a minimum distance (dₘ) equal to Tₘ−(T−d). In other words, the rectilinear surface 34 of the splines 30 must be spaced from the innermost surface 22 of the keyways 20 by at least the minimum thickness Tₘ. Therefore, the inner diameter Dis of the shaft 10 at the splines is equal to Dᵢ−(2*dₘ). As used herein, when referring to the minimum distance dₘ the splines 30 extend from the inner surface of the shaft 10, the minimum distance dₘ is the radial distance taken from the inner surface of the shaft 10 to center portion of the rectilinear surface 34 of the splines 30. In other embodiments, where the splines 30 have a cross sectional shape other than the trapezoidal cross-sectional shape or is curvilinear then the minimum distance the splines 30 must extend from the inner surface of the shaft 10 must be with reference to and consideration of a maximum depth d of the keyways 30. Accordingly, the equations, methods, and steps may vary in obtaining both the distance the splines 30 may extend from the inner surface of the shaft 10 and the profile of the splines 30, but always maintaining the desired minimum thickness Tₘ of the shaft 10. It is understood that in certain examples Tₘ=T=Tₛ and in other examples Tₘ<T<Tₛ or Tₘ<Tₛ<T or Tₘ<T=Tₛ In one example, the shaft 10 is formed from a metal such as a low carbon steel.

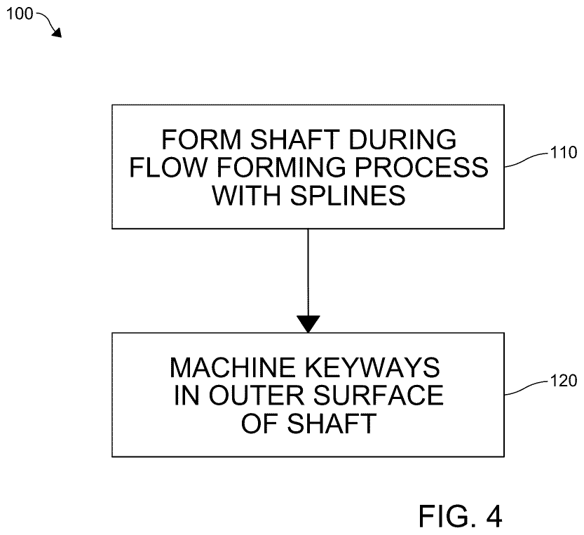

Although, other materials can be employed as desired such as other metals or plastics. FIG. 4 illustrates a method 100 of forming the shaft 10. In a first step 110, the shaft 10 is formed during a flowforming process. Flowforming is a cold forming process in which a set of roller tools apply pressure to a rotating workpiece, or preform, over a mandrel tool to form a symmetrical part. The rollers deform the preform, forcing it against the tool (also known as a mandrel), axially lengthening and radially thinning the material. The splines 30 are formed during the flow forming process. For example, the flowforming process can include localized additional material to form the splines 30 or depressions are formed in the mandrel tool to form the splines 30. The cross-sectional shape and amount of material and dimensions required for the splines 30 can be determined before the flowforming process based on the requirements and dimensions of the keyways 20. However, other process can be used to form the shafts 10 such as extrusion processes, hot forming processes, molding processes, three dimensional printing processes, or any other processes now known or later developed.

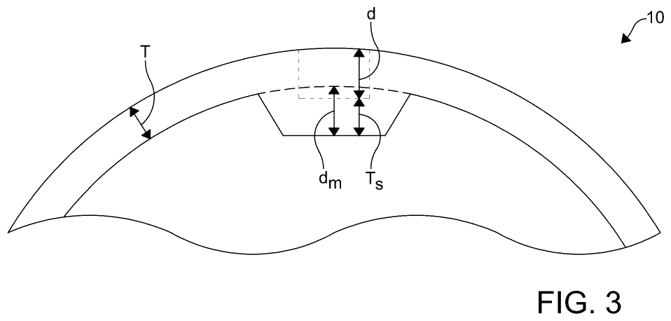

FIG. 3 illustrates an example of the shaft 10 after the flowforming process but before the step of forming the keyways 20. The dashed line in FIG. 3 illustrates where the keyways 20 will be formed. In step 120, once the shaft 30 is formed with the splines 30, the keyways 20 are formed in the outer surface of the shaft 10 by a machining process, for example. The machining process can include a broach tool, mill tool, drill tool, keysetting tool, stamping tool, combination thereof or similar tools or processes. The keyways 20 are formed to radially align with the splines 30.

Advantageously, by forming the splines 30 in radial alignment and in a configuration attuned with the present disclosure, the shaft 10 can maintain a constant thickness T, Tₛ, through and a weight of the shaft 10 is minimized.

While certain representative embodiments and details have been shown for purposes of illustrating the invention, it will be apparent to those skilled in the art that various changes may be made without departing from the scope of the disclosure, which is further described in the following appended claims.

What is claimed is:

1. A rotor shaft comprising:
a tubular shaft having an inner surface, an outer surface, a first end, and an opposing second end; and
at least one keyway formed in the outer surface of the tubular shaft, wherein an inner diameter of the tubular shaft aligned with the at least one keyway is less than an inner diameter of the tubular shaft not radially with the at least one keyway.

2. The rotor shaft of claim 1, wherein at least one spline is formed on an inner surface of the tubular shaft, the at least one spline radially aligning with the at least one keyway.

3. The rotor shaft of claim 2, wherein two keyways are formed on the outer surface of the tubular shaft and two splines are formed on an inner surface of the tubular shaft, each of the two splines radially aligning with a respective one of the two keyways, the two keyways diametrically opposed from each other.

4. The rotor shaft of claim 3, wherein the two keyways and the two splines extend along a length of the tubular shaft.

5. The rotor shaft of claim 4, wherein the two keyways have a rectangular cross-sectional shape and the two splines have a trapezoidal cross-sectional shape.

6. The rotor shaft of claim 2, wherein the tubular shaft is formed from a carbon steel.

7. The rotor shaft of claim 1, wherein the tubular shaft is a half shaft.

8. The rotor shaft of claim 7, wherein a planar interfacing surface is formed at the first end of the tubular shaft and a boss is formed at the second end of the tubular shaft.

9. A rotor shaft for an electric vehicle comprising:
a tubular shaft having an inner surface, an outer surface, a first end, and an opposing second end; and
at least one keyway formed in the outer surface of the tubular shaft, wherein a thickness of the tubular shaft aligned with the at least one keyway is substantially equal to or greater than a thickness of the tubular shaft not aligned at the at least one keyway.

10. The rotor shaft of claim 9, wherein at least one spline is formed on an inner surface of the tubular shaft radially aligning with the at least one keyway, wherein the at least one spline and the at least one keyway extend along a length of the tubular shaft.

11. The rotor shaft of claim 10, wherein the at least one spline incudes a rectilinear surface parallel to and offset from an innermost surface of the at least one keyway.

12. The rotor shaft of claim 10, wherein the thickness of the tubular shaft at the at least one keyway is substantially equal to the thickness of the tubular shaft not aligned with the at least one keyway.

13. The rotor of claim 10, wherein a base arc length of the spline is greater than a width of the at least one keyway.

14. The rotor of claim 10, wherein the tubular shaft is formed from a carbon steel.

15. A method of forming a rotor shaft for an electric vehicle comprising:
providing a preform; and
manipulating the preform to form a tubular shaft through a flow forming process, wherein an inner surface of the tubular shaft includes a spline extending along a length of the tubular shaft.

16. The method of claim 15, wherein the preform is a carbon steel preform.

17. The method of claim 15, further comprising the step of machining a keyway in an outer surface of the tubular shaft along a length thereof in radial alignment with the spline.

18. The method of claim 17, wherein the spline has a rectilinear surface, and wherein a thickness of a wall of the tubular shaft between an innermost surface of the keyway and the rectilinear surface of the spline is substantially equal to or greater than a thickness of the wall of tubular shaft not including the keyways and spline.

19. The method of claim 17, wherein the keyway has a rectangular cross-sectional shape.

20. The method of claim 15, wherein the spline has a trapezoidal cross-sectional shape.
